(19) United States
(12) Patent Application Publication
(10) Pub. No.: US 2024/0328358 A1
(43) Pub. Date: Oct. 3, 2024

(54) THERMALLY INTEGRATED AMMONIA FUELLED ENGINE

(71) Applicant: Reaction Engines Ltd., Abingdon, Oxfordshire (GB)

(72) Inventor: James E. Barth, Abingdon (GB)

(73) Assignee: Reaction Engines Ltd., Abingdon, Oxfordshire (GB)

(21) Appl. No.: 18/577,686

(22) PCT Filed: Jul. 7, 2022
(86) PCT No.: PCT/GB2022/051753

§ 371 Date: Jan. 8, 2024

(30) Foreign Application Priority Data
Jul. 9, 2021 (GB) 2109927.0

(51) Int. Cl. F02C 3/20; F02C 6/18

(52) U.S. Cl. CPC F02C 7/224; F02C 3/20; F02C 6/18

(57) ABSTRACT

A propulsion system comprising, an ammonia cracking module and an engine module, wherein ammonia is supplied to the ammonia cracking module to produce a fuel blend of hydrogen, nitrogen and ammonia, said fuel blend subsequently being fed to said engine module to produce energy; and wherein there is a thermal balance between the ammonia cracking module and the engine module.

### FIELD

The present disclosure relates to a propulsion system. In particular it relates to a system for thermally integrating an ammonia based cracking reactor into an engine, such as an engine which may be used in aerospace or other vehicle applications.

The disclosure also relates to a method for achieving such thermal integration, chemical reaction and propulsion.

### BACKGROUND

With the awareness of the relationship between global warming and carbon dioxide, the relevance of low, or ultimately zero, emission propulsion systems has increased. To achieve such emission levels, a suitable fuel is required. Hydrogen has received a lot of attention as a prospective low emission fuel but suffers from a low energy density. Ammonia is more favourable; it carries more hydrogen per mole than a mole of pure hydrogen and has a fuel density approaching that of jet fuel in liquid form.

U.S. Pat. No. 8,394,552B2 discloses a power system for an aircraft including a solid oxide fuel cell system which generates electric power for the aircraft and an exhaust stream, whereby a heat exchanger transfers heat from the exhaust stream of the solid oxide fuel cell to a heat requiring system or component of the system.

“Energy and exergy analyses of direct ammonia solid oxide fuel cell integrated with gas turbine power cycle” (Ishak, Dincer & Zamfirescu, Journal of Power Sources, Volume 212, Pages 73-85) discloses the integration of a direct ammonia solid oxide fuel cell with a gas turbine in a combined cooling, heating and power cycle.

GB1392781A, GB1392782A and GB1392783A disclose reaction propulsion engines and methods of operating them, in particular relatively small and lightweight air breathing reaction propulsion engines which will be able to accelerate efficiently a load from standstill to hypersonic speeds.

WO2019/035718 A1 discloses a zero emission propulsion system and generator set using ammonia as a fuel for engines and power plants such as steam boilers for steam turbines.

US2012/0301814 A1 discloses the use of ammonia as a fuel in electrically driven aircraft and US2018/0319283 discloses an aircraft which is configured to receive electrical power from a fuel cell which can be run on ammonia.

These prior disclosures all fail to directly address the challenges of utilising ammonia as a fuel in a jet engine. The disclosures do not account for the relatively slow chemical kinetics of thermolytic decomposition of ammonia that would result in untenably large heat exchangers being required to achieve the requisite flow residence times that fuel flow rate demands would act to counter. The disclosures also do not account for the challenges of integrating a heat exchanger at the end of a combustor, where thermal non-uniformities will also drive heat exchanger wall thickness (and therefore mass) above what would be acceptable for a flight system.

None of these prior art documents address the challenges of utilising ammonia as a fuel in a jet engine. For example, there is no mention in any of the prior art identifying a key challenge to using ammonia in a heat exchanger at intermediate pressures: ammonia will boil if held below its critical pressure of 113 bar. Still less is there any discussion of or disclosure of a solution to this problem. Boiling in the heat exchanger matrix will lead to difficult-to-predict changes in the internal convective heat transfer coefficient, as well as this local heat flux condition being unstable in location and time. This has serious implications for the design and operability of an ammonia-cooled heat exchanger.

The present disclosure seeks to alleviate, at least to a certain degree, the problems and/or address, at least to a certain extent, the difficulties associated with the prior art.

### SUMMARY

According to a first aspect of the present disclosure there is provided a propulsion system comprising; an ammonia cracking module; and an engine module wherein ammonia is supplied to the ammonia cracking module to produce a fuel blend of hydrogen, nitrogen and ammonia, said fuel blend subsequently being fed to said engine module to produce energy; and wherein there is a thermal balance between the ammonia cracking module and the engine module.

Optionally, the propulsion system comprises a turbine engine.

Optionally, the engine system comprises an engine suitable for use in an aircraft.

Optionally, the engine system comprises an engine suitable for use in a watercraft or in a vehicle on land.

Optionally, the ammonia cracking module comprises a cracking reactor formed from a series of one or more modular reactors. Advantageously, this allows the number of reactors in use to be regulated and thereby maintaining a high overall system efficiency. Such a configuration also allows for individual reactors be removed for maintenance purposes, without decommissioning the entire cracking reactor.

Optionally, the propulsion system comprises a means for bypassing a portion of the incoming ammonia around the cracking reactor. Advantageously, this allows the temperature of the fuel mixture entering the combustion chamber to be regulated, and also allows the specific ratio of hydrogen, nitrogen and ammonia to be regulated. This feature is beneficial for accommodating changes in fuel composition which may be required as a result of operating conditions i.e. an aircraft during takeoff could benefit from a different fuel composition compared with a cruising aircraft.

Optionally, the ammonia cracking system comprises at least one low pressure fuel pump and one high pressure fuel pump positioned upstream of said cracking reactor. Advantageously, the positioning keeps the components away from high pressure hydrogen-bearing gas stream, which minimises the overall risk of leaks due to hydrogen embrittlement.

Optionally, the thermal balance is achieved by way of a heat exchanger configured to exchange heat between the ammonia stream and the air stream. It is understood that the heat exchangers can be positioned to take heat from the air stream before the combustion chamber, or the exhaust gases leaving the combustion chamber. The heat exchangers preferably combine thousands of small thin-walled tubes which provide an optimum surface-area-to-weight ratio, wherein the tubes allow for an extremely efficient and effective cooling process. Preferably, such heat exchangers should be compact and lightweight. Such heat exchangers may, for example, be those as manufactured by Reaction Engines Ltd.

Optionally, the heat exchanger may be a recuperative heat exchanger. It is understood that a recuperative heat exchanger recovers waste heat from the exhaust stream in order to heat the ammonia supply stream. Such heat exchangers may be compact and lightweight, in order to meet the size and weight constraints imposed by the vehicle in which the ammonia handling module is being used.

Optionally, the recuperative heat exchanger is positioned to exchange heat between the incoming ammonia stream post high pressure compression and the outgoing exhaust stream leaving the low pressure turbine.

Optionally, a second heat exchanger contributes to the thermal balance by exchanging heat between the incoming ammonia stream and the incoming air stream.

Optionally, a second heat exchanger contributes to the thermal balance by exchanging heat between the incoming ammonia stream post high pressure compression and the incoming air stream post low pressure compression.

Optionally, the thermal balance is achieved by way of a recuperative heat exchanger positioned to exchange heat between the incoming ammonia stream post high pressure compression and the outgoing exhaust stream leaving the high pressure turbine and a second heat exchanger contributes to the thermal balance by exchanging heat between the incoming ammonia stream post high pressure compression and the incoming air stream post low pressure compression.

Optionally, a second heat exchanger contributes to the thermal balance by exchanging heat between the incoming ammonia stream post high pressure compression and the air intake stream pre low pressure compression.

Optionally, a second heat exchanger contributes to the thermal balance by exchanging heat between the incoming ammonia stream post high pressure compression and the air intake stream.

Optionally, the propulsion system further comprises a fuel cell module, wherein said ammonia cracking module is thermally balanced with both said engine module and said fuel cell module.

Optionally, the ammonia cracking module is thermally balanced with the engine module by a recuperative heat exchanger configured to exchange heat between the ammonia stream and the combustion chamber exhaust stream and wherein the ammonia cracking module is thermally balanced with the fuel cell module by a heat exchanger configured to exchange heat between the ammonia stream and the outgoing combustion chamber exhaust stream.

Optionally, the ammonia cracking module is thermally balanced with the engine module by a recuperative heat exchanger configured to exchange heat between the incoming ammonia stream post high pressure compression and the outgoing exhaust stream leaving the low pressure turbine and the ammonia cracking module is thermally balanced with the fuel cell module by a heat exchanger configured to exchange heat between the incoming ammonia stream post low compression and the outgoing exhaust stream leaving the high pressure turbine.

Optionally, the fuel cell module comprises a supercritical CO₂ driven bottoming cycle.

Optionally, the fuel cell module comprises a directly-driven gas turbine driven bottoming cycle.

Optionally, the fuel cell module comprises an auxiliary combustor.

Optionally, the combustion chamber exhaust gases are treated to remove nitrous oxides.

A method for propelling a vehicle; wherein ammonia is supplied to an ammonia cracking module and wherein said ammonia is at least partially cracked by said ammonia cracking module to produce a fuel blend of hydrogen, nitrogen and ammonia, and said fuel blend is fed to an engine module to produce energy.

### BRIEF DESCRIPTION OF THE DRAWINGS

The present disclosure may be carried out in various ways and embodiments of the disclosure will now be described by way of example with reference to the accompanying drawings, in which:

FIG. 1 is a schematic view of a generic example of an ammonia-based jet engine including a cracking reactor thermally integrated with an ammonia-fueled jet engine via a recuperative heat exchanger;

FIG. 2 is a schematic view of a modular ammonia reactor such as could be used as the cracking reactor shown in FIG. 1;

FIG. 3 is a schematic view of an example of a cracking reactor thermally integrated with an ammonia-fueled jet engine via a recuperative heat exchanger further including a heat exchanger positioned post the high pressure air compressor;

FIG. 4 is a schematic view of an example of a cracking reactor thermally integrated with an ammonia-fueled jet engine via a recuperative heat exchanger further including a heat exchanger positioned between the low pressure and high pressure air compressors;

FIG. 5 is a schematic view of an example of a cracking reactor thermally integrated with an ammonia-fueled jet engine via a heat exchanger positioned between the low pressure and high pressure air turbines further including a heat exchanger positioned between the low pressure and high pressure air compressors;

FIG. 6 is a schematic view of an example of a cracking reactor thermally integrated with an ammonia-fueled jet engine via a recuperative heat exchanger further including a heat exchanger positioned on the air stream entering the low pressure air compressor;

FIG. 7 is a schematic view of an example of a cracking reactor thermally integrated with an ammonia-fueled jet engine via a recuperative heat exchanger further including a heat exchanger positioned on the air intake stream;

FIG. 8 is a schematic view of an example of a cracking reactor thermally integrated with an ammonia-fueled jet engine further including an integrated ramjet system, with a recuperative heat exchanger and a heat exchanger positioned on the air intake stream;

FIG. 9 is a schematic view of an example of a cracking reactor thermally integrated with an ammonia-fueled jet engine via a recuperative heat exchanger further including an ammonia turbine;

FIG. 10 is a schematic view of an example of a cracking reactor thermally integrated with an ammonia-fueled jet engine via two recuperative heat exchangers further including an ammonia turbine and the use of ammonia as a heatant for the cracking reactor;

FIG. 11 is a schematic view of an example of a cracking reactor thermally integrated with an ammonia-fueled jet engine and a fuel cell system, including a supercritical CO₂ bottoming cycle;

FIG. 12 is a schematic view of a porous tube heat exchanger for use in treating emission streams.

FIG. 13 is a schematic view of an example of a cracking reactor thermally integrated with an ammonia-fueled jet engine via a series of heat exchangers with high pressure ammonia compression post catalytic cracking.

FIG. 14 is a schematic view of an example of a cracking reactor thermally integrated with an ammonia-fueled injection engine via a series of heat exchangers with high pressure compression post catalytic cracking.

FIG. 15 is a schematic view of an example of a cracking reactor thermally integrated with an MD-TJ42 engine.

FIG. 16 is a schematic view of a CFM56 engine with numbering as identified in Table 3.

FIG. 17 is a schematic view of an example of a cracking reactor thermally integrated with a CFM56 engine with numbering as identified in Table 3 and lettering as identified in Table 6.

### DETAILED DESCRIPTION

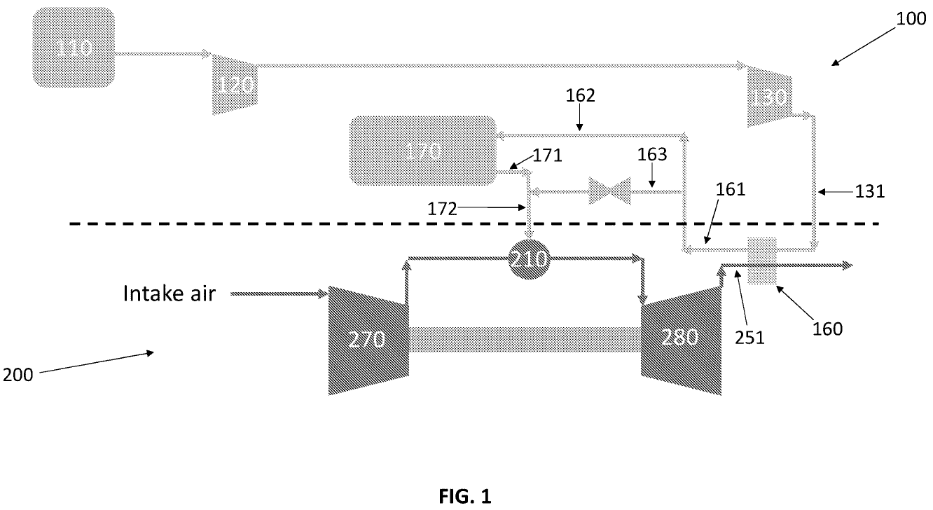

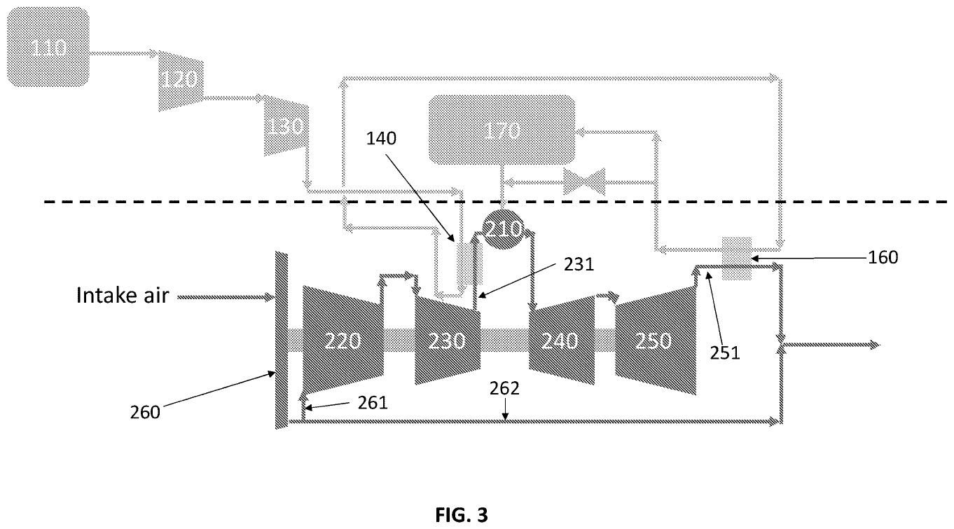

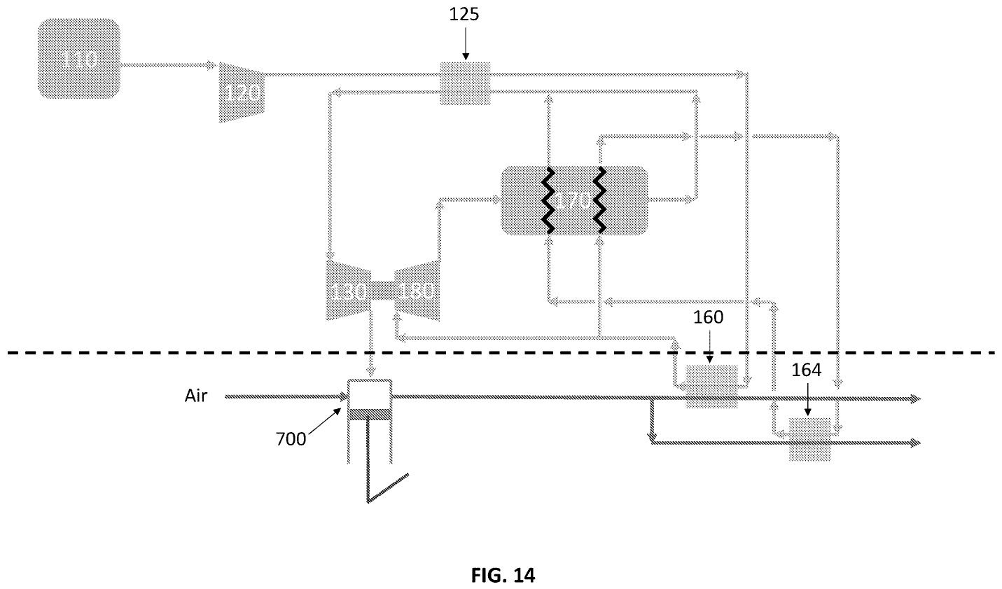

Referring to FIG. 1, a propulsion system is illustrated. The propulsion system contains an ammonia handling module 100 and an engine module 200 which is thermally integrated with the ammonia handling module. In FIG. 1, the engine module is a turbine engine, however, it will be appreciated that the propulsion system will work with other engine types i.e. a turbofan engine as seen in FIG. 3 or an internal combustion engine as seen in FIG. 14.

The ammonia handling module contains an ammonia source 110 from which ammonia is supplied to the rest of the system, a low pressure (LP) fuel pump 120 for compressing the source ammonia and a high pressure (HP) fuel pump (130) for further compressing the stream leaving the low pressure fuel pump 120. After leaving the HP fuel pump 130, the ammonia stream is passed through a recuperative heat exchanger 160 and fed to a cracking reactor 170. The heated ammonia stream 161 leaving the recuperative heat exchanger is split to create two streams; the first stream 162 is fed to the cracking reactor 170 and the second stream 163 bypasses the cracking reactor. The effluent from the cracking reactor 171 may then be mixed with the bypass stream 163 and may then be fed to the combustion chamber 210 of the engine module 200. Intake air is fed through a compressor(s) 270 to the same combustion chamber 210. Exhaust gases from the combustion chamber are used to drive a turbine 280 and heat from the exhaust stream 251 may be removed to heat the ammonia feed stream 131, via the recuperative heat exchanger 160.

Ammonia is stored in the ammonia source 110 at a temperature of between 200 K and 230 K, and at a pressure of 1 bar to 2 bar. Such storage conditions may give an approximate 18% improvement in fuel density over pressurised storage and has the additional benefit of not requiring specialist tank shapes that may be necessary to hold pressurised fluids. For example, liquid ammonia stored at a pressure of 1 bar and a temperature of 200 K has a density of approximately 728 kg/m³ and liquid ammonia stored at a pressure of 10 bar and a temperature of 298 K has a density of approximately 603 kg/m³. Advantageously, this means that the ammonia handling module of the present invention may be retrofitted into current aircraft configurations with minimal modification. In order to enable the storage of such subcooled ammonia, insulation may be necessary.

In order to prevent boiling flows inside the heat exchanger 160, the ammonia stream is pressurised by passing the ammonia through two compression stages; one low pressure 120 and one high pressure 130. These fuel pumps are preferably both upstream of the cracking reactor 170 in order to minimise the number of components that will be exposed to a high-pressure hydrogen-bearing gas stream and therefore minimise the overall risk due to hydrogen embrittlement and leaks. The ammonia may be pressurised to above its critical pressure (113 bar) and held there until the temperature has been raised sufficiently to enable transition from a supercritical fluid directly into a gas phase without any boil off. Such phenomena can be challenging to predict and can make controlling the heat transfer rates inside the heat exchanger difficult.

The ammonia stream is heated as it passes through the recuperative heat exchanger 160, whereby sensible heat is transferred from the combustion chamber exhaust stream 251 into the pressurised ammonia stream 131, 161. This additional heat provides the necessary energy for the ammonia cracking process. While the heat exchanger is shown in this position in FIG. 1, it will be understood that multiple heat exchangers may be used and that the heat exchangers may also be arranged in other configurations, as shown in FIGS. 3-10.

The heat exchangers preferably used in the present invention combine thousands of small thin-walled tubes which provide an optimum surface-area-to-weight ratio, wherein the tubes allow for an extremely efficient and effective cooling process. Preferably, such heat exchangers should be compact and lightweight. Such heat exchangers may, for example, be those as manufactured by Reaction Engines Ltd. For aero propulsion systems especially, further constraints on the design of the heat exchangers, and other components, are size and weight. Each component must be capable of fitting in the vehicle body. For example, for use in a typical single aisle aircraft (e.g. A320) engine, the mass of the heat exchangers may be less than 200 kg and the specific thermal transfer rates may be as high as 250 kW/kg. For uses in other vehicle types, although the design of each component will also be restrained by size, they may not necessarily be constrained by weight as they will represent small portion of the overall weight of the system. For example, on a ship, compactness may be important, but overall mass constraints could be somewhat relaxed. Overall scales would be larger, as maritime engines (particularly reciprocating engines) are much larger. Similarly, on a train, HGV, or car, such a system would value compactness as well, but mass constraints may be somewhat relaxed.

Residence times within the thin-walled tubes of the heat exchangers may be a few seconds. This is advantageous as the construction materials may be somewhat catalytic to ammonia and long residence times could therefore result in undesirable cracking of ammonia in the heat exchanger. To ensure that short residence times will be sufficient, it is necessary that a fluid with a consistent cooling capacity is used. Pressure drops on the engine air/exhaust side will be minimised in heat exchanger designs. Typically, they will be approximately 5% or less of the inlet pressure, in order to minimise performance/thrust losses. All heat exchangers have been illustrated as being configured to run counter currently, however, it will be understood that other configurations of heat exchangers may also be used.

The ammonia stream exiting the recuperative heat exchanger may be split so that a bypass stream 163 bypasses the cracking reactor. The amount of ammonia that is bypassed may be regulated. Advantageously, this allows any heat lost during the endothermic cracking process to be topped up by the bypass stream 163 and also allows for the precise control of the actual cracking fraction of the fuel that is injected to the combustion chamber 210, permitting different fractions of liberated hydrogen to be used at different stages of the engine cycle (i.e. take-off and cruise). The heated ammonia stream 131 which passes to the cracking reactor is cracked into hydrogen and nitrogen by high temperature catalytic cracking using bi-metallic transition metal catalysts, or light metal amide/imide catalysts such as those developed by The Science and Technologies Facilities Council (STFC). Such catalysts are preferred due to their low cost and high performance at relevant conditions. Alternatively, any ammonia-cracking catalyst may be used. The cracking may be incomplete such that only a portion of the ammonia entering the cracking reactor 170 is cracked into nitrogen and hydrogen. For example, 28% of the ammonia may be cracked to give a fuel with the same energy density as conventional jet fuel. Such a catalyst is required to enable a smaller reactor size to be used and still achieve a better performance and will ensure that heat exchangers do not need to be excessively large such that they could not be used in many transport environments, particularly in aircraft. The reactor could be designed to provide any blend of ammonia, nitrogen and hydrogen, up to 100% hydrogen.

The cooler cracked ammonia stream 171 leaving the cracking reactor may be combined with the bypassed heated source ammonia stream 163 to form a stream 172 which may be injected to the combustion chamber of the engine, along with the compressed intake air. It is expected that combustion pressures may be as low as 3 bar to as high as 70 bar for gas turbines, or as high as 100 to 200 bar for injection combustion engines.

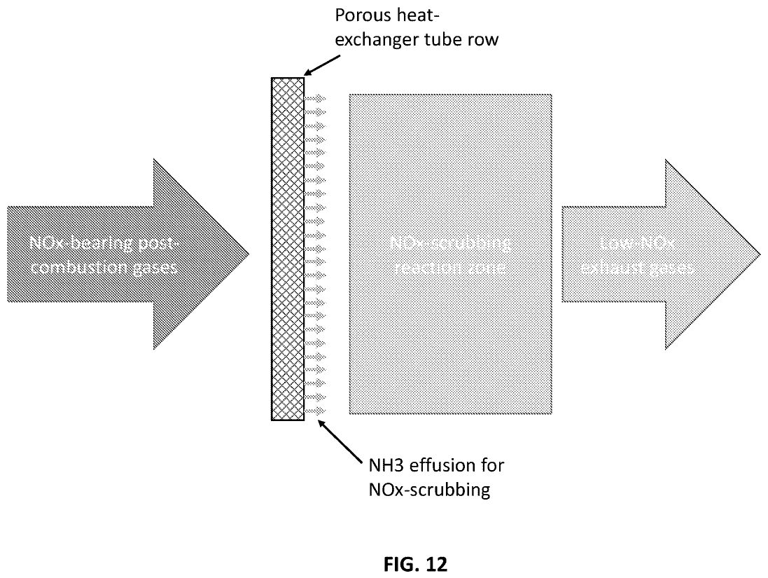

The exhaust gases from the combustion chamber will be mainly nitrogen and water vapour. Any nitrous oxides that are formed during the combustion process may react directly with uncracked ammonia to produce nitrogen and water vapour. One way of facilitating this reaction would be through the incorporation of porous tube stages in a heat exchanger located somewhere between the combustion chamber and the engine exhaust. Such tubes could also incorporate catalytic material to improve nitrous oxide scrubbing behaviours. A schematic example of a porous tube stage heat exchanger is shown in FIG. 12.

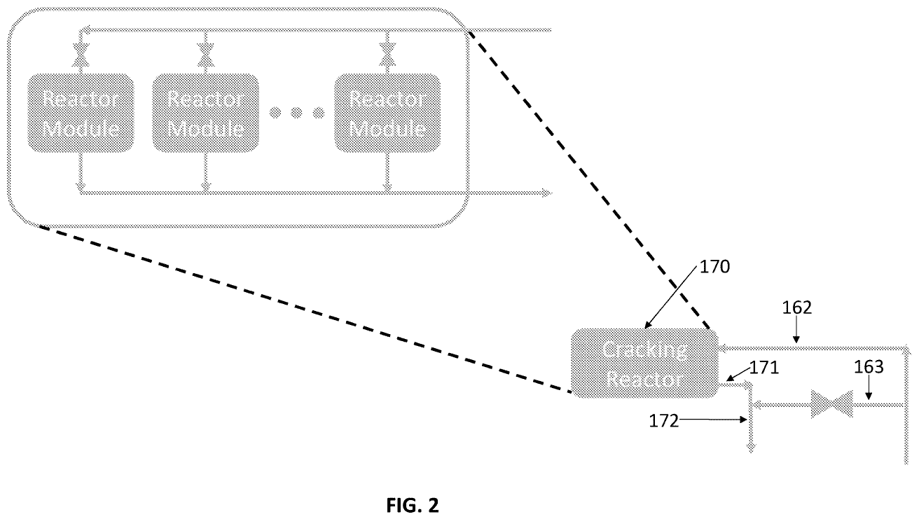

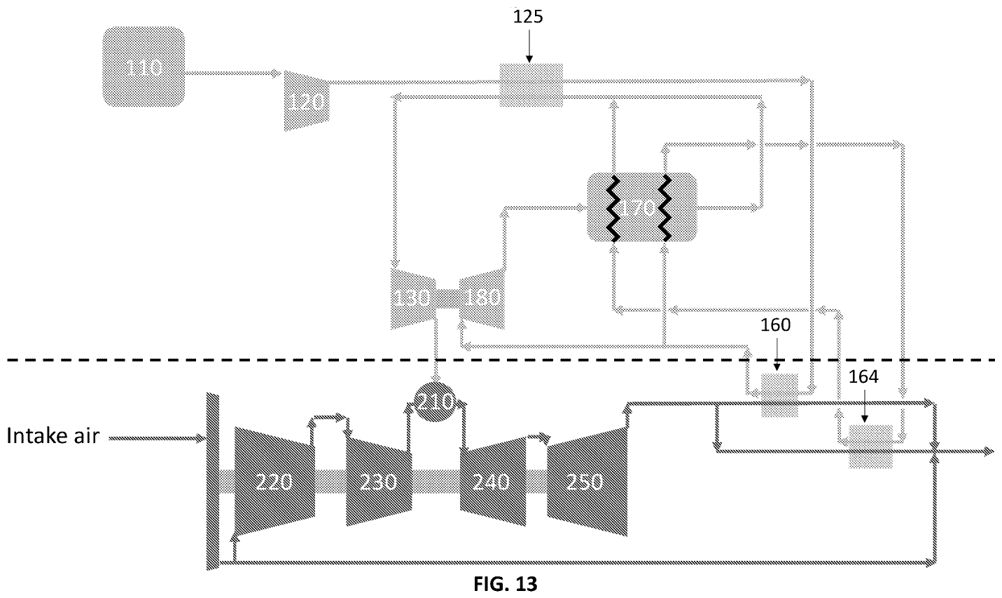

Optionally, the cracking reactor 170 may be in a modular arrangement, as is illustrated in FIG. 2. A series of modular reactors may be arranged in parallel within a global reactor module such that the number of reactor modules in use at any one time can be controlled through, for example, the use of various valves. Each module may in turn be made up of further sub-modules. Preferably, it is envisaged that such a global reactor module would include up to 10 individual reactors. The optimum number of reactors will vary depending on the application. Advantageously, this allows individual cracking reactors to be activated/deactivated as the amount of ammonia which needs to be cracked changes, thereby allowing a high overall system efficiency to be maintained during the flight. This also allows for easier maintenance and operability, allowing individual modules to be isolated and/or replaced without necessarily replacing the global reactor module. Typically, the cracking reactor would be maintained at a temperature of 725 K to keep cracking efficiencies high. Typically, the cracking reactor would be sized to fully crack 30% of the mass flow at maximum mass flow conditions (which usually occur at take-off), with the remaining 70% being bypassed around the catalytic reactor or being used as heatant for the reactor (as shown in FIGS. 13 and 14). Flowrates may vary depending on the application but, for a large gas turbine engine, the total flowrate is likely to be in the range of 10's g/s up to several kg/s.

It is to be understood that components of these systems may be arranged differently. For example, the recuperative heat exchanger 160 positioned to remove heat from the combustion chamber exhaust stream may be arranged in a different configuration or additional heat exchangers may be included. Instead of recovering heat from the air stream, it may be necessary that auxiliary heating of the cracking reactor is required to reach high enough temperatures to crack the ammonia. Examples of such further configurations can be seen in FIGS. 3-11 and 13-14. It is to be noted that such a system may be applicable to any style of combustion engine.

If consistently high temperatures were available to drive the ammonia cracking, multiple heat exchangers could be used before passing the ammonia stream to the cracking reactor. In FIG. 3, the ammonia feed stream is heated through a heat exchanger 140 positioned on the air inlet stream 231 leaving the high pressure compressor and is then passed to the recuperative heat exchanger 160 positioned on the combustion exhaust stream 251. By having a first ammonia heat exchanger downstream of the compressor and removing latent heat from the compressed air stream 231, combustion temperatures could be lowered which could reduce the likelihood of the formation of harmful Nitrous oxides during combustion. Instead of a turbine engine, FIG. 3 illustrates a turbofan engine. The engine module 200 additionally includes a fan 260. The intake air is passed through the fan 260. A portion of this air 261 is then fed to the compressors and the combustion chamber. A portion of the air 262 may bypass the engine.

A further option to reduce the production of unwanted nitrous oxides may be to react the ammonia with nitrous oxides produced during combustion to produce nitrogen and water vapour. This could be achieved through staged combustion systems, or by incorporating porous tube stages in a heat exchanger located between the combustor and the engine exhaust, for example, in the recuperative heat exchanger. An example of a heat exchanger using such tubes in shown in FIG. 12.

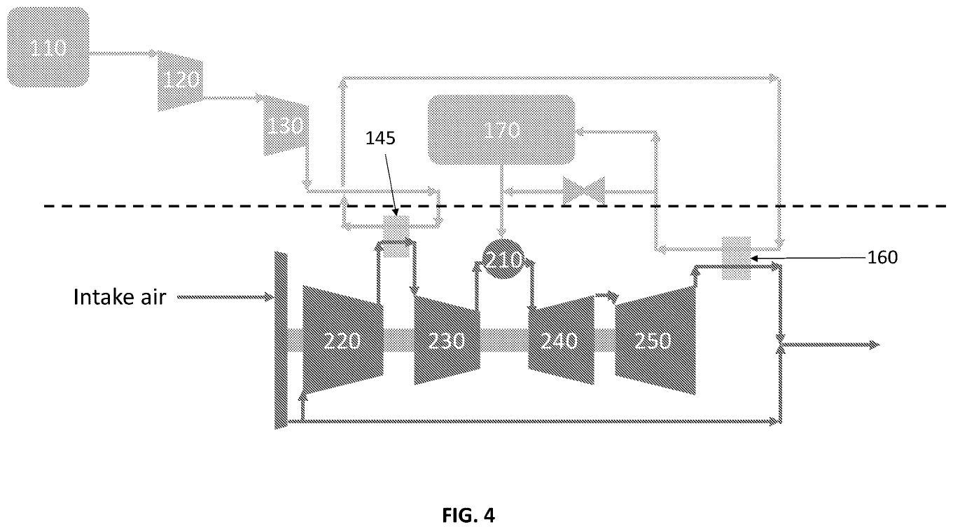

FIG. 4 shows a variation on the heat exchanger arrangement seen in FIG. 3. Instead of removing heat from the air stream 231 post the high pressure compressor, the ammonia feed stream may be contacted with the air inlet stream using a heat exchanger 145 placed between the low pressure and high pressure air compressors 220, 230. Although this may have less impact on combustion temperatures, it could significantly lower compressor work which would free up more power for electrical generation or other uses.

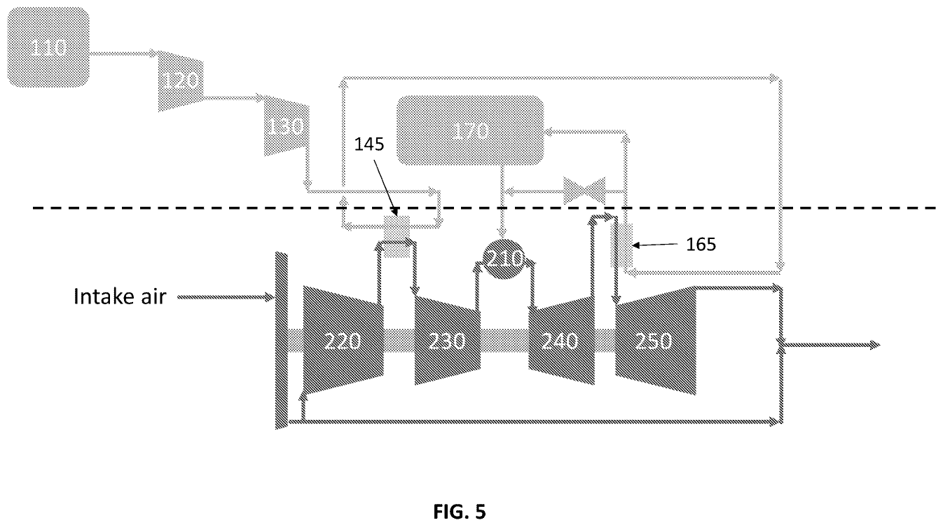

FIG. 5 shows a variation on the heat exchanger arrangement seen in FIG. 4. The recuperative heat exchanger 160 placed on the combustion air exhaust stream 251 is replaced with a heat exchanger 165 positioned on the exhaust gas stream between the high pressure 240 and low pressure 250 turbines. Advantageously, this position gives a consistently high temperature flow from which to extract heat to drive ammonia cracking, regardless of operating point, but requires careful design of the low pressure turbine 250 to ensure enough power is available to drive the low pressure compressor 220 and any upstream equipment, such as fans.

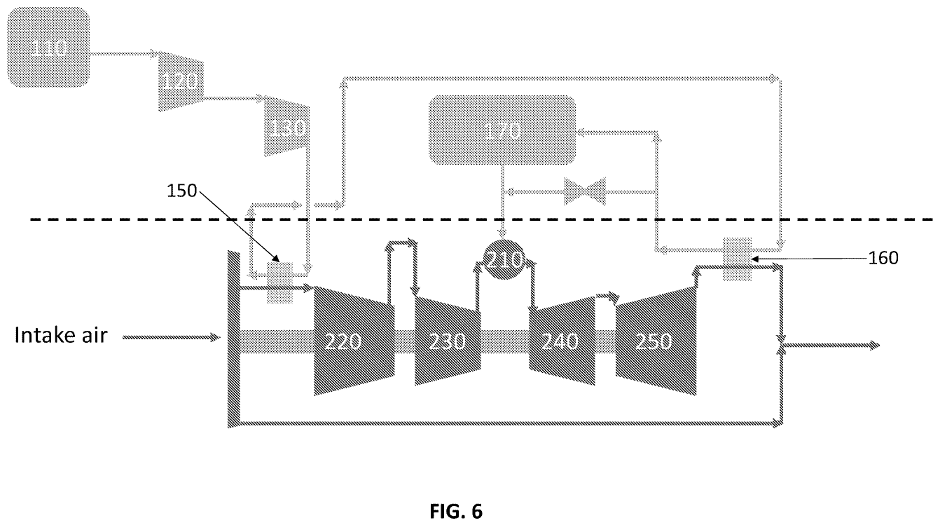

FIG. 6 shows a variation on the heat exchanger arrangement seen in FIG. 3. The post high pressure compressor heat exchanger 140 is replaced with a heat exchanger 150 positioned on the air stream entering the low pressure compressor 220. This provides similar advantages to the heat exchanger shown in FIG. 3. Advantageously, having the pre-cooling heat exchanger in this position allows for much higher Mach numbers, as the gas core may be thermally isolated from ram compression heating effects. At high Mach numbers, the air would be slowed before entering the engine, increasing its temperature. At high speeds, it is therefore possible to reach temperatures at which the high pressure air compressor 230 would start to melt. Pre-cooling the air stream entering the engine would prevent such melting. This cooling of the air has the added advantage that it would lower compressor work.

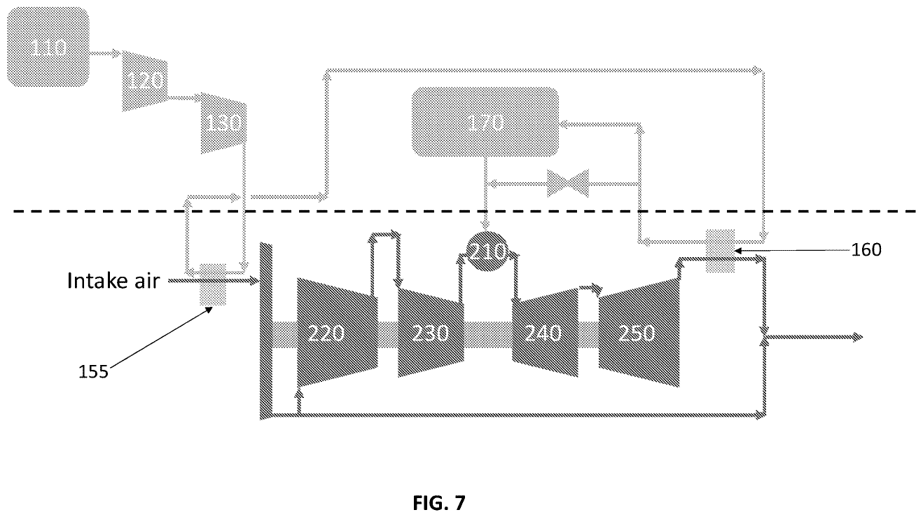

FIG. 7 shows a variation on the heat exchanger arrangement seen in FIG. 6. The heat exchanger 150 positioned on the air stream entering the low pressure compressor 220 is replaced with a heat exchanger 155 positioned on the air intake stream, before the air passes through the fan 260. This heat exchanger heats the ammonia stream using all of the intake air, unlike the heat exchanger 150 shown on FIG. 6 which only uses the portion of air which is fed to the compressor 220. Advantageously, this would reduce the total work required by any bypass fan stage (if present).

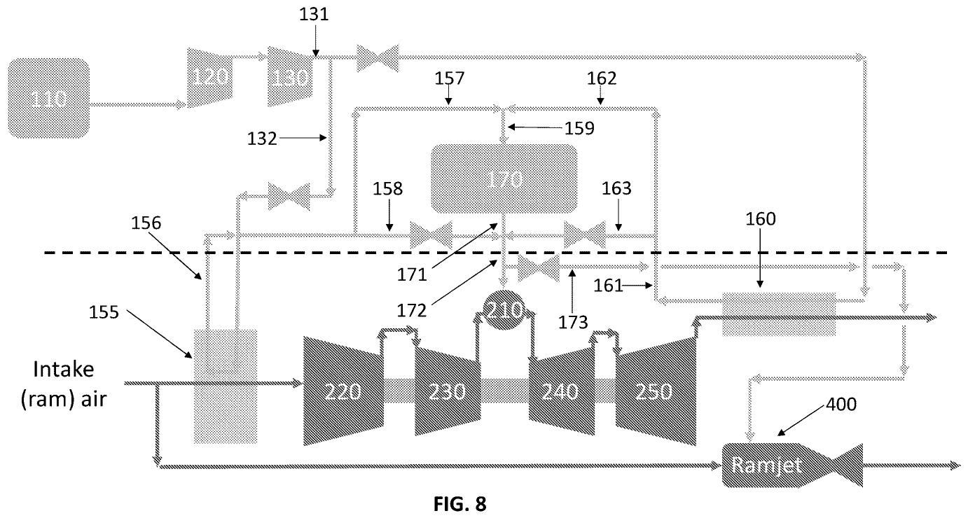

FIG. 8 shows a variation on the configuration of the ammonia handling module and engine module as shown in FIG. 1. The turbine engine of FIG. 1 has been replaced with a turbofan engine with a ramjet module. Because of the high-speed engine type, the fan 260 has been removed. Additionally, after leaving the high pressure fuel pump 130, a portion of the ammonia stream is taken off to produce a second ammonia stream 132. This second ammonia stream 132 is heated using a precooler heat exchanger 155 positioned on the air stream entering the low pressure compressor. After leaving the heat exchanger 155, the ammonia stream 156 is split to create two separate streams: the first stream 157 passes to the cracking reactor and a second stream is diverted to produce a bypass stream 158. The heated ammonia stream 157 is combined with the ammonia stream 162 heated using the recuperative heat exchanger 160 and the mixed stream 159 is fed to the cracking reactor 170. The mixing fraction can be continuously varied throughout flight: at low speeds, virtually all ammonia will be heated by the recuperative heat exchanger 160, whilst at high Mach numbers, a larger share will pass through the precooler heat exchanger 155. Before mixing with the ammonia stream 157 heated using the precooler heat exchanger 155, a portion of the ammonia stream 161 may be taken off in order to bypass the cracking reactor in cases where a lower overall cracking fraction may be advantageous. This bypass stream 163 is then combined with the effluent stream 171 from the cracking reactor and the bypass stream 158 from the ammonia stream heated using the recuperative heat exchanger 155. The mixed stream 172 is then fed to the combustion chamber 210 and, optionally, a separate stream 173 may be taken off and fed to the ramjet module 400, balancing fuel supply to give optimum efficiency at any given flight speed. A portion of the unheated air intake stream is fed to the ramjet system 400 for combustion and thrust generation at high Mach numbers.

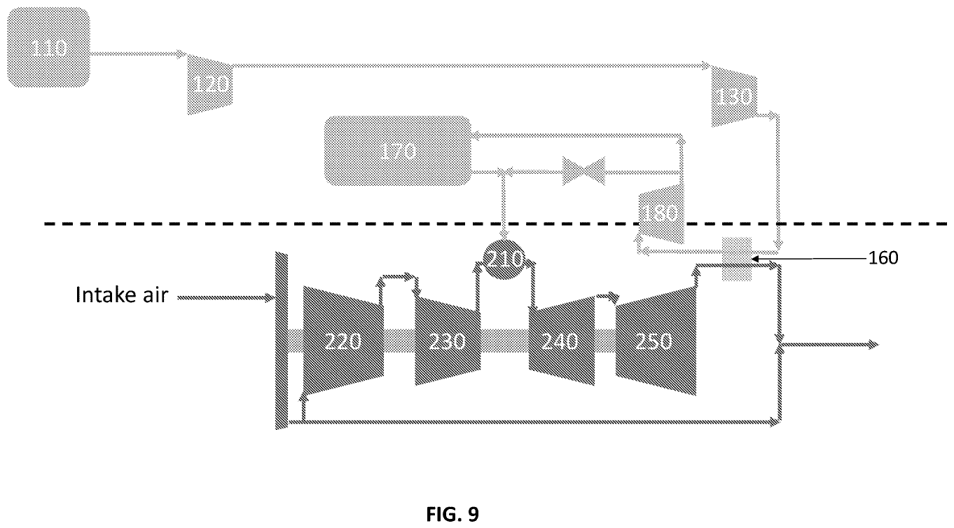

FIG. 9 shows a variation on the configuration seen in FIG. 1. An ammonia turbine 180 may be placed after the precooler heat exchanger 160 to extract useful work from the heated ammonia stream. Advantageously, this allows useful work to be extracted from the ammonia stream to power on board components, including the high-pressure ammonia fuel pump 130.

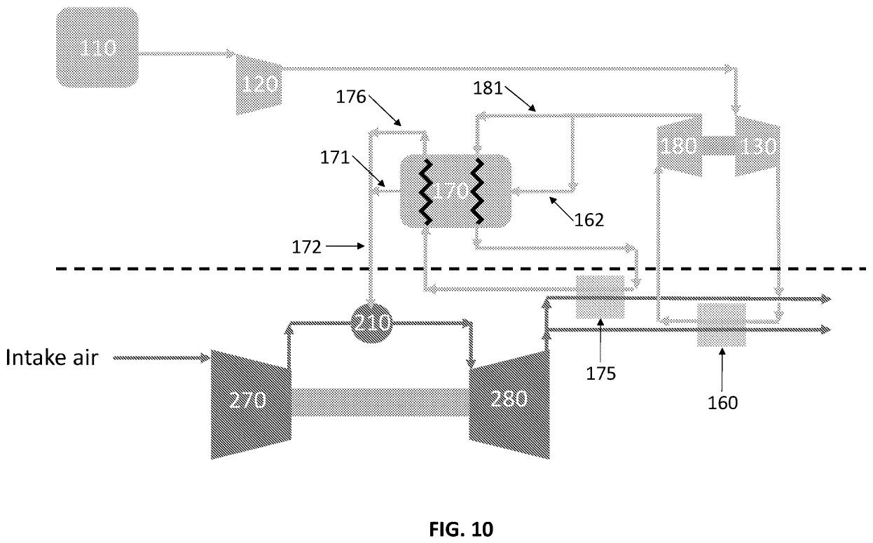

FIG. 10 shows a variation on the configuration seen in FIG. 9. The configuration is illustrated using a simple turbine engine, instead of the turbofan engine seen in FIG. 9. After the heated ammonia stream passes through the ammonia turbine 180, a stream 162 feeds a portion of the ammonia to the cracking reactor 170. Before entering the cracking reactor, a stream 181 of the ammonia is diverted from entering the cracking reactor and is utilised as a heatant for the cracking reactor. It is envisaged that the two streams may be split in a ration of around 30:70, with 30% being fed to the cracking reactor. After being used to heat the reactor, the ammonia stream is passed to a recuperative heat exchanger 175, and is then used again as a heatant for the cracking reactor 170. The cracked ammonia stream 171 leaving the cracking reactor is then combined with the ammonia stream 176 being used as a heatant before it is passed to the combustion chamber 210. The combustion chamber exhaust stream is split to form two parallel streams and one of the heat exchangers 160, 175 is positioned on each of the streams. This is done due to the significantly higher thermal capacity of the combustion chamber exhaust stream relative to the ammonia stream, as well as ensuring a lower overall pressure loss in the exhaust stream, which helps preserve as much thrust as possible.

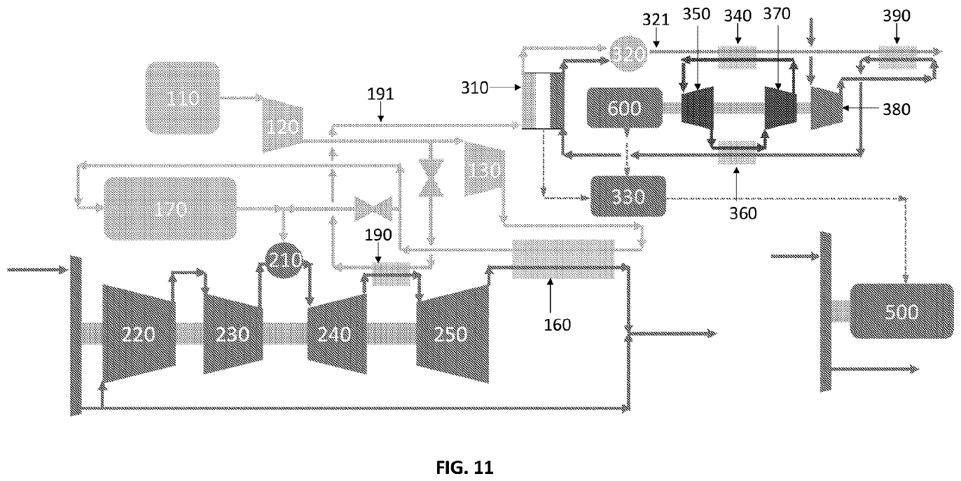

Optionally, a portion of the ammonia stream may be taken off from the ammonia handling module 100 and passed to a fuel cell module 300 where it is consumed to generate electrical power. Such a system is shown schematically in FIG. 11. Optionally, the ammonia stream 191 that is fed to the fuel cell module 300 may be taken from the ammonia handling system between the low-pressure fuel pump 120 and high-pressure fuel pump 130. Optionally, a heat exchanger 190 may heat the ammonia stream 191 by removing sensible heat from the combustion chamber exhaust stream 241 after expansion through the high-pressure turbine 240.

The fuel cell module contains a SOFC (Solid Oxide Fuel Cell) 310, an auxiliary combustor (AC) 320, and a bottoming cycle. The heated ammonia stream 191 from the ammonia handling system 100 is passed to the SOFC 310 where it is consumed to generate Direct Current electrical power which is supplied to a power conditioning unit (PCU) 330 and then to an electrical motor 500. The PCU conditions and manages the energy coming from different power sources and delivers it to other components in an appropriate form. For example, the PCU 330 may convert the Direct Current power generated by the fuel cell 310 into Alternative Current electrical power and supply this power to other components.

Any remaining ammonia which is not consumed in the SOFC and air exhausted from the SOFC may be then fed to an auxiliary combustor (AC) 320. The heat from the AC exhaust gas stream 321 may be used to drive a bottoming cycle that generates further electrical energy. A bottoming cycle is understood to be a thermodynamic cycle that generates electricity from waste heat. A heat exchanger 340 heats compressed supercritical CO₂ by transferring sensible heat from the AC exhaust gas stream 321. The supercritical CO₂ is then expanded through a turbine 350 to generate electrical power, and passed to a second heat exchanger 360 for cooling before being compressed once again by a compressor 370. At least a part of the energy generated by such a cycle may be used to compress an air inflow stream used in the fuel cell and bottoming cycle. The air inflow stream may be bled from the engine module air compressor 220, 230 or could be an altogether alternative air inflow stream (as illustrated in FIG. 11). After the air inflow has passed through the compressor 380, it is passed through a heat exchanger 390 which heats the air by removing further sensible heat from the AC exhaust gas stream 321. The heated air inflow may then be passed to the second heat exchanger 360 which removes heat from the expanded supercritical CO₂, further heating the intake air before passing the air to the SOFC 310. The expansion of the supercritical CO₂ drives a generator 600 which supplies AC electrical power to a PCU 330 and then to an electrical motor 500. Optionally, the supercritical CO₂ cycle may be replaced with a directly-driven gas turbine (not illustrated). It is to be understand that components of the fuel cell module 300 may be arranged differently. In particular, the heat exchangers may be located in different positions.

FIG. 13 shows a variation on the configuration seen in FIG. 1, where the combustor operates at pressures which are high enough to degrade performance in the cracking reactor. As a result, the high-pressure fuel pump 130 is placed after the cracking reactor 170. After passing through the low-pressure fuel pump 120, the ammonia stream is heated using a first heat exchanger 125 and then further heated using a recuperative heat exchanger 160. The ammonia stream leaving the first recuperative heat exchanger 160 is then split; a first portion is fed to a turbine 180 and then fed to the cracking reactor 170. The ammonia turbine 180 may be used to power the high-pressure ammonia fuel pump 130. A second portion of the ammonia stream leaving the recuperative heat exchanger 160 is used to heat the catalytic reactor 170 and is then heated using a second recuperative heat exchanger 164 before once again being used to heat the catalytic reactor 170 and then finally being combined with the reactor effluent stream. As the ammonia cracking reactor is highly endothermic, it is necessary to ensure that the reactor is supplied with sufficient heat. Splitting and heating the ammonia stream in the way described will allow sufficient heat to be supplied to the cracking reactor 170 to maintain the required catalytic reactor temperature, without which a further heat source may be required. The mixed effluent stream is cooled using the first heat exchanger 125 before it is passed to the high-pressure fuel pump 130 and fed to the combustion chamber 210. Heating the cracking reactor with the split ammonia stream arrangement as described in relation to FIG. 13 may be done when using any of the configurations as seen in FIGS. 1-11. Heating the reactor in this way may be required to provide enough heat to the reactors to achieve a 30% conversion of ammonia to nitrogen and hydrogen. However, a lower conversion could be achieved by not splitting and using the ammonia stream to heat the cracking reactor.

FIG. 14 shows a variation on the configuration seen in FIG. 13, where the turbofan engine has been replaced with a piston engine (internal combustion engine) 700. In such engines, injection pressures can be extremely high and so the high-pressure fuel pump 130 has been placed after the cracking reactor 170 where high pressures can degrade performance.

Various modifications may be made to the described embodiment(s) without departing from the scope of the invention as defined by the accompanying claims.

### Modelling

FIG. 10 was used as a baseline engine cycle concept. For this study, a model of a MD-TJ42 engine was created using the GasTurb software. The design reference points are listed in Table 1. Several difficulties were encountered in creating this model-most notably that designing to the quoted full throttle thrust of 250 N at 97,000 rpm consistently gave compressor sizes that were mismatched to the available geometry. Knowing that the engine was capable of 420 N thrust, but had been de-rated for service, the current reference point design was shifted to match this thrust level. The geometry more closely resembles the available data, and achieves the desired compressor Overall Pressure Ratio (OPR) of 3.8. The cycle reference point also matches the quoted exit pressure, and exhaust temperature. It should be noted at this point that the model includes a bleed for turbine blade cooling between Stations 3 and 4, hence there is a lower mass flow rate in Station 4 than would otherwise be expected, with the balance made up at Station 5.

TABLE 1
MD-TJ42 Engine Cycle reference points

| | W (kg/s) | T (K) | P (bar) |
|---|---|---|---|
| Station 2 - Compressor Inlet | 0.727 | 288.15 | 0.98285 |
| Station 3 - Compressor Exit | 0.727 | 461.17 | 3.80000 |
| Station 4 - Combustor Exit | 0.705 | 1240.46 | 3.68600 |
| Station 41 - Turbine Inlet | 0.727 | 1219.33 | 3.68800 |
| Station 5 - Turbine Exit | 0.741 | 1063.0 | 1.87225 |
| Station 8 - Nozzle exit | 0.741 | 1063.0 | 1.77863 |

This reference point is for the baseline engine, running on jet fuel. There will be some effects of switching to an ammonia fuel, but the engine is expected to have no trouble running. The exact effects were not studied in this project through the creation of a generalised tool for modelling an ammonia-based system. Rather efforts were focused on the much better documented and more complicated CFM56-3 engine. Suffice to say at this point that a single-spool machine is perfectly capable of rebalancing despite slightly higher mass flow rates and post-combustion temperatures in an ammonia-based system.

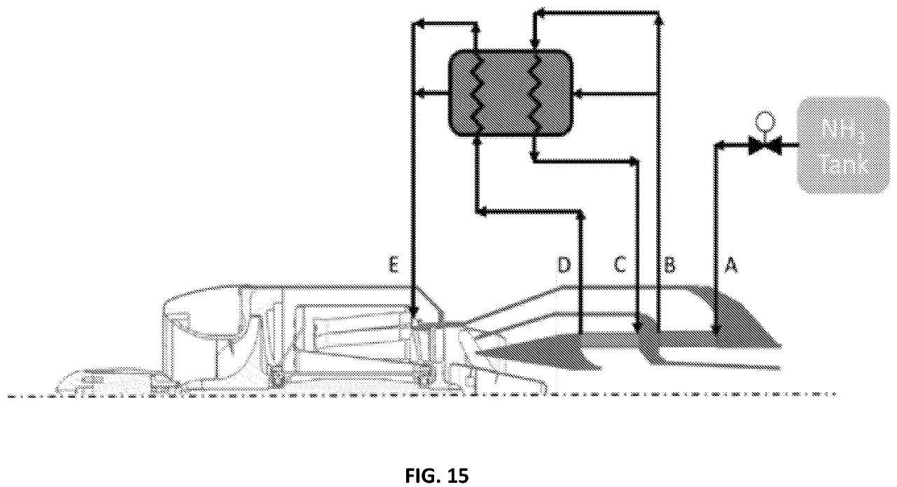

The ammonia cycle assumed for the demonstrator is simpler than that for an application engine, taking advantage of the fact that the engine is stationary during testing. As shown in FIG. 15, the ammonia supply is assumed to be pressure fed from a reservoir, eliminating the need to design new ammonia pumps during the demonstrator program. The calculated design points indicated in the Figure are listed in Table 2. The cycle developed in this section presumes the use of STFC's amide-imide catalysts.

The ammonia is presumed to be supplied to the first heat exchanger at 288.15 K, and 7 bar pressure. The ammonia-side pressure drop through the first and second recuperators are 0.98 bar and 0.9 bar respectively. This gives a total pressure budget for the flow through the catalytic reactor of 2 bar, and flow through the two reactor heating passes of roughly 0.5 bar each. Pressure drops through connecting piping are considered negligible.

Based on these numbers, a 7 bar supply pressure should be sufficient to drive ammonia through the system and still reach the MD-TJ42 combustor above its combustor pressure of 3.8 bar, and lower than its maximum fuel pressure of 4.5 bar. This is considered ideal, as this ensures ammonia is supplied in a gaseous state. However, if more pressure is needed, a simple heater to ensure a supply temperature of 298K permits a supply pressure increase to 9.5 bar without any worry of liquefaction.

TABLE 2
Demonstrator ammonia cycle reference points.

| | W (kg/s) | T (K) | P (bar) |
|---|---|---|---|
| Station A | 0.0411 | 288 | 7.00 |
| Station B | 0.0411 | 911 | 6.02 |
| Station C | 0.0288 | 750 | 5.51 |
| Station D | 0.0288 | 906 | 4.61 |
| Station E | 0.0411 | 750 | 4.00 |

If even higher pressures were found to be necessary, it may be necessary to account for boiling, as the ammonia would likely be in a liquid state at the point of supply. In this case, cooling the air flow duct with a channeled sleeve (similar to how rocket nozzles are cooled) may be an ideal solution for boiling the fuel. As mentioned below, there is a significant amount of engine exhaust not passed through one of the two recuperators, leaving ample thermal energy available if such a boiler were necessary.

### Conceptual Flight Application

In discussing a potential new zero-carbon propulsion system, it is worth examining what it might look like at a practical scale, and what impact it would have on a real aviation system. For this section, the Airbus A320 and CFM56 engine have been chosen as the baseline for this study. This combination is one of the main workhorses of the narrow-body jet/short-haul civil aviation market, and an option to retrofit existing fleet aircraft with a zero-carbon alternative is more attractive than devising a novel aircraft configuration. The A320 and CFM56 also have widely available performance data on which to base a study.

### CFM56-Based Cycle

This section first examines the feasibility of ammonia as a drop-in fuel in a multi-spool engine, and then develops a full cycle based around the engine.

As with virtually any jet engine currently on the market, there are no publicly available performance maps for the turbomachinery within any variant of the CFM56. There is, however, a reasonably large database of publicly available data for the CFM56-3. This data can be used to derive a set of model maps for the engine, matched as closely to available data as possible. The CFM56-3 would be challenging to use in a recuperator-only cycle (its lower exhaust gas temperature would require far more heat exchangers than some later models), but it is still useful to model as the ability to ‘drop in’ cracked ammonia fuel would be indicative of the same ability in subsequent derivative models such as the CFM56-5 models used by the A320 aircraft family.

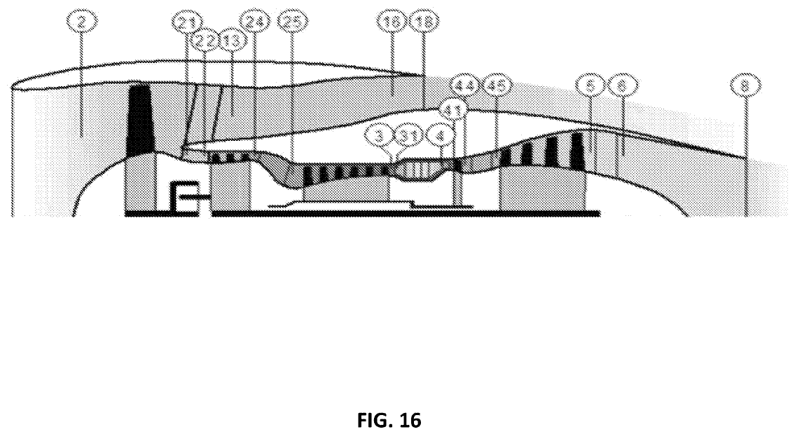

A set of performance maps for the CFM56-3 were derived, providing the design reference point for normal operation (i.e. using jet fuel) shown on the left half of Table 3. (Station numbers match the numerical values shown in FIG. 16.) This reference point matches Exhaust Gas Temperature (EGT), engine thrust, OPR, and Thrust Specific Fuel Consumption (TSFC) quite closely, giving confidence that its maps will be of reasonable fidelity as a basis for the study.

With this information, it was therefore possible to investigate if the engine turbomachinery can be balanced when jet fuel is replaced with ammonia that has had 28% of its mass cracked into hydrogen and nitrogen. The literature has suggested that this is relatively straightforward (as the slight drop in specific enthalpy is made up for by an increase in mass flow), but much of this literature was published in the 1960's, when single-spool turbojets were the norm. Modern literature on ammonia combustion has similarly focused on single-spool gas micro turbines. As such, while this gives confidence that a simple demonstrator like the one proposed in the previous section will be straightforward to change fuels, a two spool machine may be more challenging.

It should be noted at this point that all investigations were done manually. Combustion was modelled directly using NASA's Chemical Equilibrium with Applications (CEA) code, and all fluid property calculations necessary to determine station conditions were done using RefProp. When reading conditions off the turbine maps, the maps were rescaled to account for the changes in flow and blade Mach number due to the fluid property changes caused by a shift to ammonia fuel.

GasTurb itself could have been used to do this work, but was ruled out for two reasons. One of these concerns was about the fidelity of combustion modelling for non-hydrocarbon fuels. With how well-studied jet fuel combustion is, there was some worry that the relatively simplistic method for developing a new fuel model in GasTurb (which requires only two calculations with CEA) would involve (semi-) empirical models to correct the equilibrium results across a wide range of fueling conditions and account for details such as Nitrous oxide formation.

Another serious concern was to do with how GasTurb models flow through the turbines: jet fuel combustion tends to yield a flow with a specific heat ratio (γ) similar to that of air. GasTurb therefore only varies the specific gas constant (R) to account for humidity effects on turbine operating points, and holds the specific heat ratio constant. There is, however, literature to suggest that correctly accounting for the specific heat ratio can alter the actual pressure ratio and efficiency obtained when scaling an existing map between different working fluids. Whilst previous literature has dealt exclusively with compressors, the same relationship for turbines are straightforward to derive:

$${PR}_{B} = {[ 1 - \frac{{η}_{A}}{{η}_{B}} ( \frac{{γ}_{B} - 1}{{γ}_{A} - 1} ) ( 1 - P {R}_{A}^{{θ}_{A}} ) ]}^{1 / {θ}_{B}} , where θ = \frac{γ - 1}{γ}$$

n is the turbine's isentropic efficiency, PR is its pressure ratio, and subscripts A and B refer to the original reference fluid and the fluid of interest, respectively. This relationship was used when calculating turbine operating points in the ammonia-fueled engine. The choice was made for this modelling exercise to assume differences in efficiency with different working fluids were negligible, and the efficiency values read off the model maps were therefore unchanged.

As a starting point, an attempt was made to rebalance the engine with the simplest change: replacing the jet fuel with cracked ammonia at the same equivalence ratio (ER). It was immediately obvious that the extra ˜1.5 kg of mass flow required moving the high pressure spool operating point, as the high pressure turbine's Nozzle Guide Vanes (NGVs) are choked across a large fraction of its map. This was simple enough to accomplish, requiring the high pressure compressor to operate at a pressure ratio roughly 4% higher than normal by either running up its constant relative speed line, or along a constant surge margin line.

The resulting new combustion condition was high enough pressure and temperature to easily power-balance the high pressure spool, at a matched spool speed. While this confirms the previous statement that balancing a single spool machine is reasonably simple, it comes at a potential engine ‘lifing’ cost:

turbine inlet temperature and spool speed both increase by approximately 2%. This would decrease useful engine lifetime in a ‘drop-in’ fuel scenario.

While the high pressure spool balances easily in this case, the condition it yielded at the low pressure turbine inlet was nowhere on the available map; both pressure and temperature needed to come down to move it into an operable state. An attempt was made to do this by shifting as much of the compressive work in the engine onto the high pressure spool, which managed to get a condition actually physically on the low pressure turbine map. Unfortunately, the only parts of the map available were mismatched both on available work and spool speed.

The decision was thus taken to allow the fuel equivalence ratio (ER) to change, specifically lowering the ER to reduce combustion temperature. After several iterations, a condition was found that results in an engine that has both the high pressure and low pressure spools power-balanced. The low pressure fan and compressor were held at their design point, and the high pressure compressor needed a slight (0.9%) increase in pressure ratio. With ER dropping from 0.3534 to 0.289, a power-balanced cycle reference point is obtained, shown on the right half of Table 3 (station points are defined in FIG. 16).

TABLE 3
CFM56-3 cycle reference points using
jet fuel or 28% cracked ammonia.

| | Jet Fuel | | | Ammonia Fuel | | |
|---|---|---|---|---|---|---|
| | W | T | P | W | T | P |
| Station | (kg/s) | (K) | (bar) | (kg/s) | (K) | (bar) |
| 2 | 313.7 | 288.15 | 1.01325 | 313.7 | 288.15 | 1.01325 |
| 13 | 260.838 | 338.15 | 1.67693 | 260.838 | 338.15 | 1.67693 |
| 21 | 52.862 | 288.52 | 1.01730 | 52.862 | 288.52 | 1.01730 |
| 22 | 52.862 | 288.52 | 1.01730 | 52.862 | 288.52 | 1.01730 |
| 25 | 52.862 | 369.92 | 2.21976 | 52.862 | 369.92 | 2.21976 |
| 3 | 52.862 | 770.82 | 24.4984 | 52.862 | 773.79 | 24.74602 |
| 31 | 45.462 | 770.82 | 24.4984 | 45.461 | 773.79 | 24.74602 |
| 4 | 46.557 | 1576.59 | 23.2734 | 47.619 | 1469.75 | 23.50872 |
| 41 | 50.257 | 1522.07 | 23.2734 | 51.319 | 1426.08 | 23.50872 |
| 43 | 50.257 | 1164.08 | 5.46888 | 51.319 | 1082.14 | 5.46691 |
| 45 | 53.429 | 1142.20 | 5.46888 | 54.491 | 1065.94 | 5.46691 |
| 5 | 53.429 | 862.58 | 1.48140 | 54.491 | 786.76 | 1.37614 |
| 8 | 53.958 | 861.72 | 1.46658 | 55.020 | 785.84 | 1.36238 |
| 18 | 259.333 | 338.15 | 1.64017 | 259.333 | 338.15 | 1.64017 |

The turbine spool speeds were not perfectly balanced due to time constraints, but achieving this would be only a matter of further iteration, and the result gives confidence that a multi-spool machine can be operated ammonia as a drop-in fuel. The decrease in fuel mass flow significantly lowers the high pressure turbine entry temperature (6.3%, or 96 K), while recovering a very similar entry condition for the low pressure turbine to the jet-fueled case. This suggests the guideline for balancing a two-spool engine is to simply attempt to keep the low pressure inflow corrected flow rate as close as possible to the original cycle design point.

FIG. 16 CFM56 Station Numbering. Engine Image from [RD]18].

As indicated by Station 5 (the low pressure turbine exit), the ammonia-fueled engine has turbine exit temperature and pressures which are both approximately 9% lower than for the jet-fueled case. As summarised in Table 4, this in turn reduces the core thrust of the engine by 11%, and overall engine thrust by 2.5% due to the unchanged bypass air providing the majority of the thrust. Some of this performance may be recoverable: the lowered combustion temperature, for example, may lower bleed air requirements for high pressure turbine cooling, elevating flow enthalpy entering the low pressure turbine.

TABLE 4
CFM56-3 performance comparison for jet fuel versus ammonia

| | Core | Total | | | Thrust Specific |
|---|---|---|---|---|---|
| | thrust | thrust | W_{fuel} | Equivalence | Fuel Consump- |
| | (kN) | (kN) | (kg/s) | Ratio | tion (g/kN s) |
| Jet-A fuel | 22.59 | 99.28 | 1.0952 | 0.3534 | 11.03 |
| Ammonia fuel | 20.12 | 96.75 | 2.1578 | 0.2890 | 22.30 |

The impact of lowered low pressure turbine exhaust temperature will also have an effect on the performance of the integrated thermal cycle. As mentioned previously, the CFM56-3 is not an appropriate candidate for using ammonia as a ‘drop in’ fuel unless a balanced point can be found that significantly increases the station 5 temperature considerably. Our attention thus turns to the CFM56-5, the variant that powers the Airbus A320.

### CFM56-5B Thermally Integrated Cycle

The CFM56-5B series of engines was developed specifically to power the Airbus A319/320/321 family of aircraft. It features numerous design improvements over the CFM56-3 engine series, resulting in an increased OPR and a significant improvement in operating efficiency. The performance parameters of interest for the CFM56-5B4 (the variant specific to the A320) are collated in Table 5, on the right hand side.

TABLE 5
CFM56-5B4 performance characteristics
for jet fuel and ammonia (estimated)

| | Jet fuel | Ammonia Fuel |
|---|---|---|
| Take-off thrust (kN) | 121.00 | 117.00 |
| Cruise thrust (kN) | 22.41 | 21.66 |
| Take-off TSFC (g/kN s) | 9.558 | 19.240 |
| Cruise TSFC (g/kN s) | 15.320 | 30.858 |
| Take-off EGT (K) | 1163.15 | 1058.47 |
| Cruise EGT (K) | 953.15 | 867.37 |

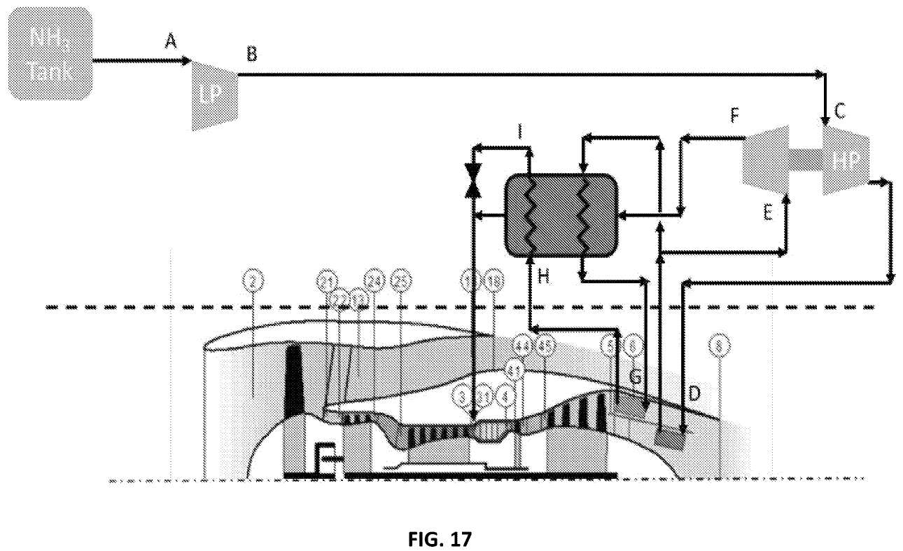

Ammonia-fueled performance has been estimated on the basis of being similar to those seen in the analysis of the CFM56-3, with an additional thrust loss due to the presence of recuperative heat exchangers. These numbers underpin the analysis of a potential cycle of the same class as seen in FIG. 15, thermally integrated with this particular jet engine as illustrated in FIG. 17. In order to properly bound the analysis, a few assumptions were made. First, fuel pressure at delivery to the burners should be at least 25% higher than chamber pressure to prevent any chance of flame propagation into the fuel system. With an OPR at max climb of 32.6, a minimum supply pressure of 41 bar should be ample for all flight conditions.

Another major assumption is that the minimum outlet pressure of the high pressure fuel pump (Station D in FIG. 17) is well above ammonia's critical pressure of 113 bar. As discussed earlier, this prevents boiling from occurring in the first heat exchanger matrix. Ammonia's properties at high temperature also require assumptions, as no reference data is available for temperatures above 700 K (likely due to the onset of thermal cracking of ammonia at low pressures).

It is assumed that flow residence times within the fuel system are low enough that endothermic cracking within the heat exchangers and pipes upstream of the reactor is negligible. It is further assumed, on the basis that change in enthalpy is quite linear as temperatures approach 700 K, that RefProp's extrapolations to higher temperatures are sufficiently accurate for heat exchange calculations, as well as for other properties needed.

### Cycle Design Point Calculations

The design point chosen is the take-off (maximum thrust) condition, with the performance requirements shown in Table 5. Based on the thrust and TSFC listed, an ammonia fuel flow of 2.251 kg/s is required by the engine.

Beginning with the inlet to the low pressure pump (Station A), it was assumed that this is at the same conditions assumed for the tank: liquid ammonia stored at 1 bar and 200 K. (In this sub-cooled condition ammonia's density is 728 kg/m³, significantly higher than pressurised ammonia at ambient conditions.) The low pressure pump is specified as having a pressure ratio of 10 at full power, and an efficiency of 60%. This requires the pump to do specific work of 2.06 KJ/kg ammonia, and gives the conditions shown for Station B in Table 6. The pipe loss between the low pressure and high pressure pumps is based on a 37 mm diameter fuel line that is half the length of the A320 (19 m). The calculated pressure drop is 0.4 bar, but is rounded to 0.5 bar to give a sensible margin, yielding the inlet conditions to the high pressure pump listed for Station C.

The high pressure pump is assumed to have the same efficiency as the low pressure pump for simplicity, and a pressure ratio of 13.5 to ensure a pressure sufficiently above the critical point at the entry to the heat exchanger. This requires a specific work of 27.13 KJ/kg. The high pressure pump is assumed to be physically close to the inlet to the first recuperator stage, and based on a 3 m length, has a pressure drop of 0.06 bar, which will be rounded to 0.1 bar to add margin.

In order to estimate the change in conditions across the recuperator, a simple set of assumptions has been made. Based on the HTX heat exchanger, the first recuperator has 10,000 1 mm outer diameter tubes with 50 micron wall thickness and a length of 2.5 m. Outflow temperature is 925 K, well within the operating limits for Inconel tubes. Using 700 K as the reference temperature for fluid properties (an assumed reasonable mid-range temperature, as air thermal capacity tends to be higher than ammonia for these heat exchangers), the matrix pressure drop is calculated to be 6.96 bar. Adding in the both upstream dynamic pressure to account for matrix losses, and a 10% margin, the Station E condition in Table 6 is obtained.

The flow is then split into reacting and heating streams, and the stream to be reacted (30% of the mass flow) is passed through a turbine to drive the high pressure pump. (This is done to minimise pump size given the reduced flow density.) The assumed shaft efficiency is 0.995, and the turbine isentropic efficiency is set at 75%. This drops the flow temperature and pressure by nearly 30 K and 30 bar upstream of the catalytic reactor (Station F).

The catalytic reactor will lose a significant amount of heat due to the endothermicity of the cracking reaction. For 28% of the mass flow converted fully to hydrogen and nitrogen, the total heat lost is 1.711 MW. Some of this heat is available in the reactant stream. Assuming a targeted outflow temperature of 760 K, and there is a 10 bar pressure drop across the reactor, the reacting flow itself can supply roughly ⅙ of the required heat (285 KW). (The targeted temperature is significantly higher than the 723 K minimum required for good catalyst operation, as higher temperatures will improve cracking yields.)

The remaining 70% of the fuel flow (the heating stream) must therefore make up the remaining 1.426 MW of heating. Presuming each heating pass provides half the required heat, it is possible to estimate the inlet condition to the second recuperator. The first reactor heating pass is given a pressure budget of 12.5 bar from its inlet to the inlet of the second recuperator, giving the condition at Station G. As the obtained temperature is above the minimum reactor temperature of 760 K, the condition is reasonable enough to base a calculation of the heating load on the second recuperator.

TABLE 6
DESIGN CYCLE POINTS FOR THE CFM56-5B4 AMMONIA FUEL SYSTEM

| | Station | | | | | | | | |
|---|---|---|---|---|---|---|---|---|---|
| | A | B | C | D | E | F | G | H | I |
| T (K) | 200.0 | 200.3 | 200.3 | 204.0 | 925.0 | 896.7 | 791.7 | 925.0 | 790.8 |
| P (bar) | 1.00 | 10.00 | 9.50 | 128.2 | 119.1 | 90.42 | 106.6 | 101.6 | 89.1 |

The second recuperator is assumed to have similar properties to the first, albeit with 2000 fewer tubes due to the reduced mass flow rate. Based on the inflow conditions at Station G, fluid properties were taken for the top temperature (the most conservative condition) the combined loss through the matrix, manifolds, and downstream ducting is 5 bar (including a 10% margin as before). This condition is Station H in Table 6, at the inlet to the second reactor heating pass.

The second reactor pass is assumed to have the same pressure drop budget as the first, and must provide the same energy to the reactor as well. This gives the second heating pass an outflow temperature and pressure of 791 K and 89.1 bar, respectively. This is roughly 10 bar higher than the budgeted outflow pressure of the catalytic reactor, which will require throttling down before mixing the two streams and delivering them to the engine combustor.

Overall, the design point appears fit for purpose, and with ample margin to meet the major concerns: pressure in the first recuperator has ample margin above the critical pressure to avoid boiling phenomena. There is ample heat to maintain the catalytic reactor at its desired operating temperature, and there is plenty of room for additional pressure loss without dropping below the desired minimum combustion fuel supply pressure. This is ideal, as it may well be that the reactor performs best at a pressure lower than 80 bar, in which case additional pressure losses would need to be introduced.

### Cruise Operation Implications

The focus thus far has been on the design point (take-off) condition. Most of the engine's operating lifetime will be spent, however, in cruise. There are a number of interesting implications for the cycle operating point for the cruise conduction for either the fuel cycle or the engine itself that can be stated with some certainty.

First, and perhaps most important, is the impact of lower implied EGT during cruise. The maximum supply temperature of the ammonia to the reactor and its heating system will be 865 K. There is room within the system to accommodate this. The minimum exit temperature can be as low as 725 K without seeing a significant drop-off in performance. The overall available energy from the system as design is 499 KW; 214 KW from each heating pass, and 69 KW from the reacting flow itself.

The available energy is just shy of the 507 KW required to offset cracking endothermic losses at cruise, but this does not necessarily mean cracking efficiency will drop off. The ammonia mass flow rate at cruise is 30% that of take-off, and this means flow residence time in the cracking reactor and heat exchangers will be lengthened. This will have a positive effect on cracking yields that may off-set any losses due to slightly lowered temperatures near the end of the catalytic reactor. If necessary, however, there is ample unused engine exhaust thermal mass and fuel system pressure drop available to allow a third heat exchanger pass. (Another alternative would be to relocate the heat exchangers to intercool between the turbine stages)

Another interesting issue is around the desire to keep the cold ammonia entering the first heat exchanger at pressures above its critical point. This would ideally be maintained during cruise as well. This implies any pump design will need to be able to supply the same pressure ratio at a significantly reduced mass flow rate. This will almost certainly also require back pressure control downstream of the main thermal components in order to drive pressures higher.

### Recuperator Effect on Engine Thrust

The recuperator heat exchangers have thus far been examined on the basis of what happens to the ammonia passing through the tubes. There is the equally important question of how the presence of the recuperators will affect the engine exhaust stream.

The compact tube heat exchangers from Reaction Engines can be produced with virtually any exhaust-side or fuel-side pressure drop desired. For the purposes of this exercise, it is assumed they have roughly twice the exhaust-side pressure drop of the demonstrator heat exchangers, or 0.14 bar. The flow split is also presumed proportional to the split in the demonstrator: 26.5% of the exhaust passes over the first recuperator, 6.1% through the second, with fully 67.4% not affected.

Based on the heat transfer required during take-off, and assuming physical properties similar to air for simplicity, the exhaust passing through the first recuperator will drop from 1058.5 K to 882.8 K. The exit temperature of the second recuperator's exhaust stream is even lower, at 862.6 K. Armed with this information, it is possible to calculate the impact on the core engine thrust, assuming the streams take a proportional share of the core exit plane area, and the force of each stream may be calculated as

$${F}_{thrust} = ( {P}_{8 , s} - {P}_{∞} ) {A}_{8} + {W}_{exhaust} {U}_{8} ,$$

where the subscript 8 refers to the core nozzle exit, W is the mass flow rate, and U is the flow velocity. Doing so results in an estimated 4% loss in core thrust relative to that estimated for an ammonia fueled engine without heat exchangers. As the core provides 20% of total thrust, the overall thrust thus drops 0.8%. This factor was calculated into the thrust presented in Table 5. This would in turn imply that an ammonia-fueled aircraft utilising this cycle would have a slightly lower cruise speed than its jet-fuel burning counterpart; it could also run at a higher throttle setting in cruise, but this would introduce an additional range penalty on top of that due to ammonia's smaller Lower Heating Value.

### Performance of an Ammonia ‘Retrofit’ A320

Having an engine cycle that, at proof-of-concept level, appears viable as an option for retrofit into existing aircraft, analysis of the impact on the range of an A320 was carried out, assuming the performance of the CFM56-5B as examined. The A320 data was taken from Airbus' publicly available aircraft manual.

It was assumed that the A320 was the WV017 model, and fitted with both additional centre tanks to maximise available range. This gives a total fuel volume of 29.659 m³, which allows for 21.6 tonnes of sub-cooled (200K) liquid ammonia to be carried on board. The aircraft has an Operating Empty Weight (OEW) of 42.6 tonnes, and a Maximum Take-Off Weight (MTOW) of 78 tonnes. It is assumed to be carrying 180 passengers with an EASA recommended mass of 105 kg, (including luggage).

Additional masses were accounted for the need for roughly 600 kg of tank insulation (aerogel blankets), as well as the thermal system components needed to crack the ammonia. The fuel pumps were presumed to be a 1:1 replacement of existing fuel pumps in terms of mass, but engine masses rise by 100 kg each, due to recuperator integration.

The reactor system itself was estimated on the basis of scaling the existing experimental reactor down, using a large number of them, and adding in the necessary thermal control and manifolding, using a system similar to a Reaction Engines concept for a fuel injection manifold to intelligently integrate multiple flows in a compact volume. The reactors were scaled on flow residence time, and then with no packing efficiency assumed, a 200% factor was applied to account for manifolds and ducting between the reactor and the engine. This gave an estimated reactor mass of 1200 kg per engine.

The updated OEW for the aircraft was therefore 45.8 tonnes when retrofitted to handle ammonia fuel. If the aircraft flies with zero payload and a full tank of fuel, its take-off weight is 67.4 tonnes. If it is assumed to be carrying 180 passengers with an EASA recommended mass of 105 kg (including luggage), then there is 13.3 tonnes remaining for fuel if the aircraft leaves the runway at MTOW. These two conditions roughly book-end the possible ranges for the aircraft retrofit for ammonia fueling.

To estimate the potential aircraft ranges, the Breguet range equation is used:

$$Range = \frac{U ( L / D )}{g ( SFC )} ln \frac{{m}_{i}}{{m}_{f}}$$

where SFC and L/D are for cruise, g is gravity, and the initial and final masses are for takeoff and landing. To get a landing mass, a 2 tonne fuel reserve is assumed. (While additional accuracy could be obtained by treating take-off and landing separately, a single calculation is considered sufficient at this early stage.) The cruise speed, U, is 224.5 m/s, based on a presumed Mach 0.76 flight at 11 km altitude. L/D is taken to be 18, a standard value quoted for the A320 in cruise.

Using the values above, the zero-payload range is estimated at 4590 km. With a full passenger complement, the range is 2090 km-enough for a direct flight from London Heathrow to reach most major European centres (or from New York's JFK airport to the Eastern half of the continental US and Canada). While this is roughly 41% of the range for a jet-fueled A320, it still is a good result for a zero carbon emission vehicle; recall that the expected range of a battery-powered narrow body aircraft in 2050 is 1100 km.

If further range were desired for a 180 passenger aircraft, it would simply be a matter of choosing a larger airframe. For example, using the same tools and similar assumptions presented above, the A321 could carry 192 passengers (83% of its rated capacity) an estimated 3140 km. This would enable direct flights from Heathrow to Ankara, and from JFK to all of Texas, Puerto Rico, and the Yucatan Peninsula. In the post-Covid era, a larger aircraft with fewer passengers may also be considered an attractive option.

1. A propulsion system comprising;
an ammonia cracking module; and
an engine module;
wherein ammonia is supplied to the ammonia cracking module to produce a fuel blend of hydrogen, nitrogen and ammonia, said fuel blend subsequently being fed to said engine module to produce energy; and
wherein there is a thermal balance between the ammonia cracking module and the engine module.

2. A propulsion system as claimed in claim 1, wherein said engine module comprises a turbine engine.

3. A propulsion system as claimed in claim 1, wherein said engine module comprises an engine suitable for use in an aircraft.

4. A propulsion system as claimed in claim 1, wherein said engine module comprises an engine suitable for use in a watercraft or in a vehicle on land.

5. A propulsion system as claimed in claim 1, wherein said ammonia cracking module comprises a cracking reactor formed from a series of one or more modular reactors.

6. A propulsion system as claimed in claim 5, wherein there is a means for bypassing a portion of the ammonia around the cracking reactor.

7. A propulsion system as claimed in claim 1, wherein the ammonia cracking module comprises at least one low pressure fuel pump and one high pressure fuel pump positioned upstream of said cracking reactor.

8. A propulsion system as claimed in claim 1, wherein said thermal balance is achieved by way of at least one heat exchanger configured to exchange heat between an ammonia stream and an air stream.

9. A propulsion system as claimed in claim 8, wherein said heat exchanger is a recuperative heat exchanger positioned to exchange heat between the incoming ammonia stream post a high pressure fuel pump and an outgoing combustion chamber exhaust stream leaving the low pressure turbine.

10. A propulsion system as claimed in claim 8, wherein a second heat exchanger contributes to the thermal balance by exchanging heat between the ammonia stream and the incoming air stream.

11. A propulsion system as claimed in claim 10, wherein a second heat exchanger contributes to the thermal balance by exchanging heat between the incoming ammonia stream post said high pressure fuel pump and the incoming air stream post a low pressure compressor.

12. A propulsion system as claimed in claim 10, wherein said thermal balance is achieved by way of a heat exchanger positioned to exchange heat between the incoming ammonia stream post high pressure compression and an outgoing exhaust stream leaving the high pressure turbine and a second heat exchanger contributes to the thermal balance by exchanging heat between the incoming ammonia stream post high pressure compression and the incoming air stream post low pressure compression.

13. A propulsion system as claimed in claim 9, wherein a second heat exchanger contributes to the thermal balance by exchanging heat between the incoming ammonia stream post high pressure compression and the air intake stream pre low pressure compression.

14. A propulsion system as claimed in claim 9, wherein a second heat exchanger contributes to the thermal balance by exchanging heat between the incoming ammonia stream post high pressure compression and the air intake stream.

15. A propulsion system according to claim 1 further comprising a fuel cell module, wherein said ammonia cracking module is thermally balanced with both said engine module and said fuel cell module.

16. A propulsion system according to claim 15, wherein the ammonia cracking module is thermally balanced with the engine module by a heat exchanger configured to exchange heat between an ammonia stream and a combustion chamber exhaust stream and wherein the ammonia cracking module is thermally balanced with the fuel cell module by a heat exchanger configured to exchange heat between the ammonia stream and the outgoing combustion chamber exhaust stream.

17. A propulsion system according to claim 15, wherein the ammonia cracking module is thermally balanced with the engine module by a heat exchanger configured to exchange heat between the incoming ammonia stream post high compression and the outgoing exhaust stream leaving the low pressure turbine and the ammonia cracking module is thermally balanced with the fuel cell module by a heat exchanger configured to exchange heat between the incoming ammonia stream post low compression and the outgoing exhaust stream leaving the high pressure turbine.

18. A propulsion system according to claim 15, wherein said fuel cell module comprises a supercritical CO₂ driven bottoming cycle.

19. A propulsion system according to claim 15, wherein said fuel cell module comprises a directly-driven gas turbine driven bottoming cycle.

20. A propulsion system according to claim 15, wherein said fuel cell module comprises an auxiliary combustor.

21. A propulsion system as claimed in claim 1, wherein combustion chamber exhaust gases are treated to remove nitrous oxides.

22. A propulsion system as claimed in claim 1, wherein an ammonia stream is split into two or more streams and at least one of said streams is used to heat the ammonia cracking module.

23. A propulsion system as claimed in claim 1, wherein a high pressure ammonia compression stage occurs after a catalytic cracking stage.

24. A method for propelling a vehicle; wherein ammonia is supplied to an ammonia cracking module and wherein
said ammonia is at least partially cracked by said ammonia cracking module to produce a fuel blend of hydrogen, nitrogen and ammonia, and
said fuel blend is fed to an engine module to produce energy.
